(19) United States
(12) Patent Application Publication
(10) Pub. No.: US 2007/0267417 A1
(43) Pub. Date: Nov. 22, 2007

(54) CONSTRUCTION MACHINE AND HYDRAULIC OIL TANK THEREOF

(75) Inventor: Isao Miyachi, Hiroshima-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KOBELCO CONSTRUCTION MACHINERY CO., LTD., Hiroshima-shi (JP)

(21) Appl. No.: 11/685,303

(22) Filed: Mar. 13, 2007

(30) Foreign Application Priority Data
May 18, 2006 (JP) 2006-139152

(51) Int. Cl. B60P 9/00

(52) U.S. Cl. 220/564

(57) ABSTRACT

A return oil filter for filtering hydraulic oil is installed on a bottom within a box-like tank which is for storing hydraulic oil, and a window hole-like filter loading/unloading port, as well as a removable lid for closing the filter loading/unloading port, are provided in a rear surface of the tank body at a position higher than a highest level of the hydraulic oil L in the tank body. A connection pipe for connection between the filter and an outer pipe is disposed within the tank body in a state in which a main pipe thereof is inclined forwardly downward from the filter loading/unloading port side toward the filter, whereby the connection pipe and the filter can be removed backward in one piece with each other from the filter loading/unloading port.

### BACKGROUND OF THE INVENTION

1. Field of the Invention

The present invention relates to a hydraulic construction machine and a hydraulic oil tank for storing hydraulic oil to be fed to hydraulic actuators of the construction machine.

2. Description of the Related Art

Heretofore, as structures for loading and unloading of a filter used in a hydraulic oil tank, the structures disclosed in Japanese Patent Laid-Open No. 2004-143707 and Japanese Utility Model Laid-Open No. Sho 58 (1983)-30002 are publicly known.

When it is premised that the filter is to be removed upward and when it is impossible to take out the filter just upward because a cover member is present above the tank, a solution to this problem is to take out the filter upward while sidestepping away from the cover member. In this connection, the following structures are disclosed in the above literatures: a structure wherein an upper surface of the tank body is inclined, a filter loading/unloading port is formed in the inclined surface and the filter is removed obliquely upward toward the exterior away from the cover member, and a structure wherein a filter case is attached obliquely to a side wall of the tank body so as to communicate with the interior of the tank body and the filter inserted into the filter case is removed obliquely upward from an upper-end opening of the case.

On the other hand, in Japanese Patent No. 3461138 there is disclosed a technique dedicated to a feed oil filter. According to this technique, the filter loading/unloading port and a lid for opening and closing the said port are formed in a lower position (lower than a highest level of the hydraulic oil in the tank body) of a side face of the tank body, the filter and the lid are connected together through a rod, and the filter is removed horizontally from the loading/unloading port simultaneously with removal of the lid.

However, the structure of taking out the filter obliquely upward as in the two literatures referred to above initially is not applicable to the case where a space for taking out the filter cannot be ensured in the upper portion including an obliquely upward portion like the case where a cover member closes the upper portion of the tank over a wide area.

Even if the space can be ensured, according to the structure disclosed in the foregoing Japanese Patent Laid-open No. 2004-143707 the tank volume is reduced because the upper surface of the tank body is cut obliquely, and according to the structure disclosed in the foregoing Japanese Utility Model Laid-Open No. Sho 58 (1983)-30002 wherein the filter case as another member is fixed to a side wall of the tank body, the tank structure is complicated and the number of parts increases; besides, machining of the tank body is troublesome, thus leading to an increase of cost.

On the other hand, according to the structure disclosed in the foregoing Japanese Patent No. 3461138, all of the hydraulic oil present within the tank body must be removed at every loading and unloading of the filter, so that the filter replacing work is extremely troublesome and it is actually difficult to apply the structure in question to a feed oil filter requiring frequent maintenance.

### SUMMARY OF THE INVENTION

It is an object of the present invention to provide a construction machine and a hydraulic oil tank having a simple structure for loading and unloading of a filter of a hydraulic oil tank and not requiring the removal of oil at the time of loading and unloading of the filter on the premise that the filter of the hydraulic oil tank is removed sideways from one of front, rear, right, and left side faces of a tank body.

The hydraulic oil tank of the construction machine according to the present invention has the following basic construction.

The hydraulic oil tank of the construction machine according to the present invention comprises a box-like tank body for storing hydraulic oil, a filter for filtering the hydraulic oil, the filter being disposed at a position lower than a highest level of the hydraulic oil in the tank body, a removable lid for closing a window hole-like filter loading/unloading port formed at a position higher than the highest level of the hydraulic oil in one of front, rear, right, and left side faces of the tank body, and a connection pipe for connection between the filter and an outer pipe, the connection pipe being connected integrally with the filter and disposed within the tank body so that it can be inserted and removed sideways into and from the tank body through the filter loading/unloading port.

According to this construction, since the loading and unloading of the filter are performed sideways from a side face of the tank body, the loading and unloading (maintenance) of the filter can be done even in the machine not having a space above the tank.

Besides, as the tank body structure for loading and unloading of the filter, there suffices a simple structure such that a window hole is formed in one side face of the tank body and is closed with a lid. Thus, machining of the tank body is easy and the number of parts used is small, therefore, the cost is low.

Moreover, since the filter installed at a position (within the oil) lower than the highest level of the hydraulic oil in the tank body is inserted and removed into and from the filter loading/unloading port formed higher than the highest level of the hydraulic oil, it is not necessary to remove oil at the time of loading and unloading of the filter. Therefore, the maintenance work becomes simple particularly when the construction in question is applied to a return oil filter requiring frequent maintenance.

In this case, since the filter is installed within the oil, there does not occur such a trouble as filtered oil dropping into the tank body, causing the formation of air bubbles, which problem occurs when the filter is positioned higher than the highest level of the hydraulic oil in conformity with the filter loading/unloading port.

It is preferable to adopt such a construction as permits the lid, connection pipe and filter to be subjected to a loading/unloading operation all together.

According to this construction, preparations for removal of the filter are made by only detaching the lid from the tank body, and upon fixing the lid to the tank body there also are completed setting and fixing of the filter into the tank body, whereby the filter loading/unloading work becomes easier.

Even when a main pipe of the connection pipe is formed vertically, it is possible to effect loading and unloading of the filter if the filter loading/unloading port is formed large. In this case, however, a wasteful increase in size of the tank body results, which is not practical. On the other hand, it is preferable to adopt a construction wherein the main pipe is inclined. According to this construction, it becomes possible to effect loading and unloading of the filter while avoiding a wasteful increase in size of the tank body.

In the construction machine which adopts the hydraulic oil tank according to the present invention, since the filter in the hydraulic oil tank can be inserted into and removed from the tank directly from the exterior, it is not necessary to ensure a space for loading and unloading of the filter within an engine room and thus the construction thereof is advantageous particularly to a small-sized excavator not having a space margin.

### BRIEF DESCRIPTION OF THE DRAWINGS

FIG. 1 is a schematic side view showing a state in which a hydraulic oil tank according to an embodiment of the present invention is installed on an upper rotating body;

FIG. 2 is a partly cut-away side view of the hydraulic oil tank;

FIG. 3 is a rear view of the hydraulic oil tank;

FIG. 4 is a partial sectional view showing a first stage of filter removal;

FIG. 5 is a partial sectional view showing a second stage of filter removal;

FIG. 6 is a partial sectional view showing a third stage of filter removal; and

FIG. 7 is a schematic side view of a small-sized hydraulic excavator to which the present invention is applied.

### DESCRIPTION OF THE PREFERRED EMBODIMENTS

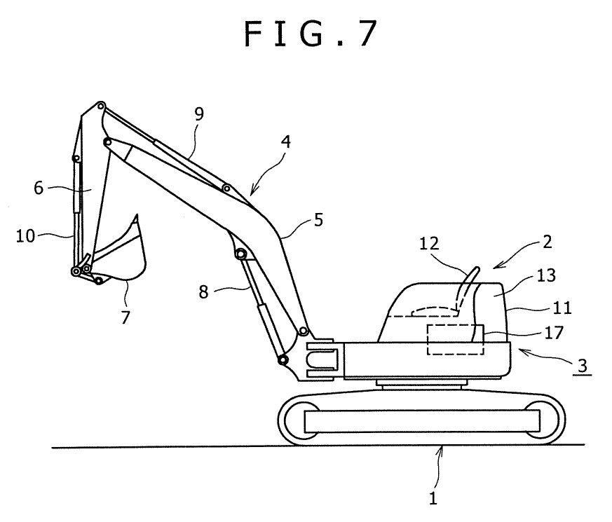

In FIG. 7 there is shown a small-sized hydraulic excavator called a mini-excavator to which the present invention is applied.

In the same figure, the numeral 1 denotes a crawler type lower traveling body. An upper rotating body 2 is mounted on the lower traveling body 1 so as to be rotatable about a vertical axis, thereby constituting a base machine 3. An excavating attachment 4 is attached to the upper rotating body 2 of the base machine 3.

The excavating attachment 4 is made up of a boom 5, an arm 6 attached to a front end of the boom 5, and a bucket 7 attached to a front end of the arm 6, which components are each mounted rotatably about a horizontal axis. With cylinders 8, 9 and 10, the boom, arm and bucket perform extending and contracting motions to carry out an excavating work.

A cover member 11 is provided in a rear portion of the upper rotating body 2 and a seat is mounted on an upper surface side of the cover member 11 to constitute an operator's seat 12. Below the operator's seat 12 (inside the cover member 11) is formed an engine room 13. Within the engine room 13 are installed an engine (not shown) serving as a power source and devices, including a hydraulic oil tank 17 for storing hydraulic oil to be fed to hydraulic actuators such as the aforesaid cylinders.

The hydraulic oil tank 17 includes a box-like tank body. The box-like tank body comprises a feed oil filter for filtering feed oil to be fed to a hydraulic pump, and a return oil filter for filtering return oil returned from the hydraulic actuators. Both filters are connected to both outer pipes for the feed oil and the return oil.

In the tank body is formed a filter loading/unloading port for insertion and removal of both filters into and from the tank body. The filters are removed from the filter loading/unloading port periodically or where required and are maintenanced (subjected to cleaning, repair or replacement).

In the following embodiment reference will be made to the foregoing small-sized hydraulic excavator as an example of a machine to which the present invention is applied.

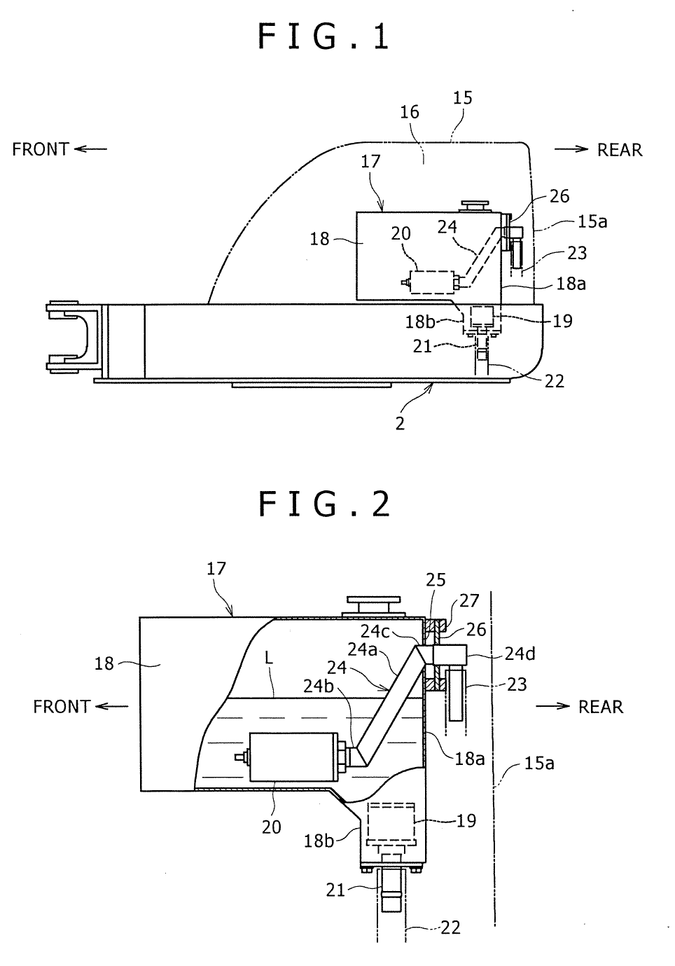

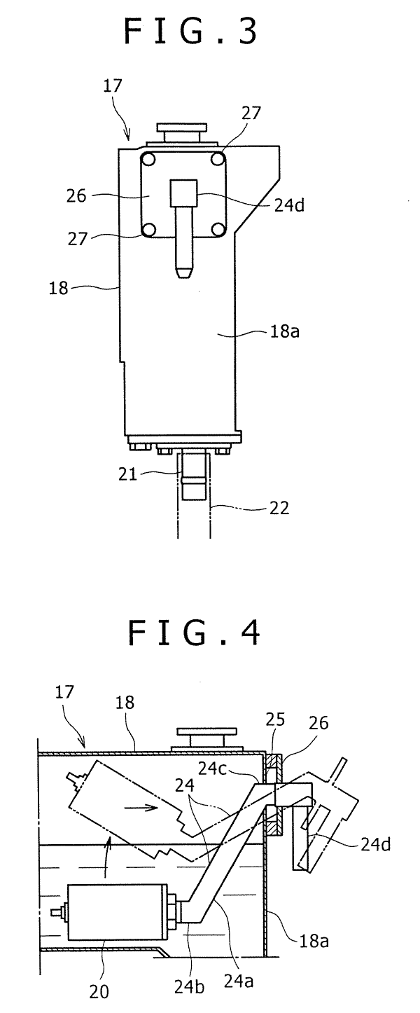

As shown in FIG. 1, a cover member 15 is provided in a rear portion of the upper rotating body 2. An engine (not shown) and devices, including a hydraulic oil tank 17, are installed within an engine room 16 formed inside the cover member 15.

The hydraulic oil tank 17 is made up of a box-like tank body 18, a feed oil filter 19 for filtering feed oil to be fed to a hydraulic pump is disposed within the tank body 18, and a return oil filter 20 for filtering return oil returned from hydraulic actuators is disposed within the tank body 18. The hydraulic oil tank 17 is installed in the rear portion of the engine room 16 in a state in which a rear surface 18a of the tank body 18 faces a rear surface portion 15a of the cover member 15.

The cover member 15 is constructed such that its rear surface portion 15a (the whole or only the portion opposed to the rear surface 18a of the tank body will do) opens like a door or is detached and can thereby be opened to the exterior. The return oil filter 20 is removed to the exterior from this open portion as will be described later.

The feed oil filter 19 is installed in a filter receptacle portion 18b projecting downward from a rear end portion of the tank body 18. A connection pipe 21 for feed oil is connected to the feed oil filter 19 and is drawn out to the exterior. Further, an outer pipe 22 for feed oil is connected to a drawn-out end of the connection pipe 21.

As shown in FIGS. 1 and 2, the return oil filter 20 extends longitudinally along a bottom (lower than a highest level of the hydraulic oil L in the tank body) within the tank body 18 in an immersed state into oil. The return oil filter 20 and an outer pipe 23 for return oil are connected together through a connection pipe 24 for return oil.

As shown in detail in FIG. 2, the connection pipe 24 for return oil is made up of a main pipe 24a which is inclined forwardly downward, a filter connecting portion 24b extending horizontally forward from a front end (inclined lower end) of the main pipe 24a, and an outer pipe connecting portion 24c extending horizontally backward from a rear end (inclined upper end) of the main pipe 24a. The return oil filter 20 is integrally connected to the filter connecting portion 24b.

In an upper portion of a rear surface of the tank body 18, that is, in a position higher than the highest level of the hydraulic oil L in the tank body, there are provided a filter loading/unloading port 25 and a lid 26 which closes the port 25.

The outer pipe connecting portion 24c of the connection pipe 24 for return oil extends through the lid 26 in a liquid-tight state and is drawn out to the exterior in a fixed state to the lid 26, and an L-shaped joint 24d is provided at a drawn-out end of the outer pipe connecting portion 24c, with the outer pipe 23 for return oil being connected to the joint 24d.

With plural bolts 27, the lid 26 is attached detachably to the filter loading/unloading port 25 and the return oil filter 20 is detached upon removal of the lid 26.

More specifically, when taking out the filter 20 for maintenance, the lid 26 is detached as in FIG. 4 in a state in which the rear surface portion 15a (the whole or a part) of the cover member 15 is opened to the exterior.

At this time, since the lid 26 and the connection pipe 24 for return oil are integral with each other and so are the connection pipe 24 and the filter 20, the lid 26, the connection pipe 24 and the filter 20 move all together as shown in the drawing.

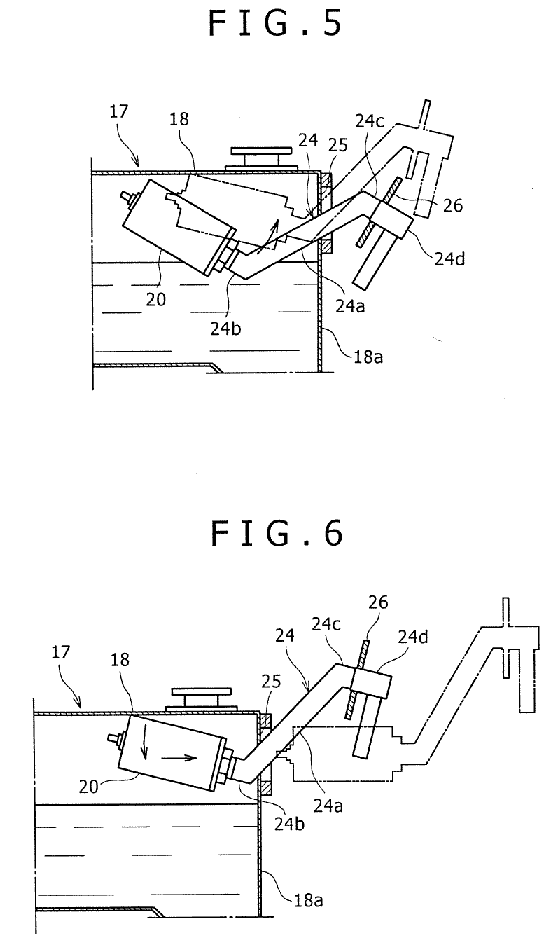

Therefore, as shown in FIGS. 4 to 6, the whole of the above integral combination of the three components can be removed to the exterior of the tank body 18 by drawing it out while changing the attitude thereof as necessary and with the joint 24d of the connection pipe 24 as a handle.

Re-installation of the filter 20 after maintenance can be done by performing operations reverse to the above filter taking-out operations. After the lid 26 is mounted again to close the filter loading/unloading port 25, the rear surface portion 15a of the cover member 15 is closed as before to terminate the work.

Thus, according to this construction, the return oil filter 20 is removed backward from the rear surface of the tank body 18, so that the filter 20 can be removed from the tank body 18 for the purpose of maintenance and can again be inserted into the tank body even when there is no space above the tank.

Moreover, as the structure of the tank body 18 for loading and unloading of the filter, there suffices a simple structure including a window hole (filter loading/unloading port 25) formed in the rear surface 18a and the lid 26 to close the window hole, so that machining of the tank body 18 is easy and the number of parts is small, with a consequent reduction of cost.

Besides, according to the above structure, the filter 20 installed at a position (bottom) lower than the highest level of the hydraulic oil L in the tank body 18 is inserted into and removed from the tank body 18 through the filter loading/unloading port 25 positioned higher than the highest level of the hydraulic oil L. Therefore, it is not necessary to remove oil at the time of loading and unloading of the filter. Consequently, it becomes easier to carry out the maintenance work for the return oil filter 20 requiring frequent maintenance to which reference is made particularly in this embodiment.

In this case, since the filter 20 is installed within oil, there does not occur such a problem as filtered oil dropping into the tank body 18, causing air bubbles, which occurs when the filter 20 is positioned higher than the highest level of the hydraulic oil L in conformity with the filter loading/unloading port 25.

In addition, the three of lid 26, connection pipe 24 and filter 20 can be inserted into and removed from the tank body 18 all together, preparations for taking out the filter are made by only detaching the lid 26 from the tank body 18, and the setting and fixing of the filter 20 into the tank body 18 are completed by fixing the lid 26 to the tank body 18, whereby the work for loading and unloading the filter 20 become easier.

Further, since the main pipe 24a of the connection pipe 24 is inclined forwardly downward from the filter loading/unloading port 25 side toward the filter 20, it is possible to avoid a wasteful increase in size of the tank body 18 in comparison with the construction wherein the main pipe 24a is formed vertically and the loading and unloading of the filter are performed through a filter loading/unloading port much larger than the filter size. Thus, the construction of this embodiment is further advantageous to such a small-sized hydraulic excavator having no margin in the engine room space as referred to herein.

On the other hand, as described above, since the rear surface portion 15a of the cover member 15 is opened, the filter 20 can be inserted into and removed directly from the exterior, it is not necessary to ensure a filter loading/unloading space within the engine room, which is also advantageous to the small-sized hydraulic excavator.

Although the above embodiment adopts the construction wherein the connection pipe 24 is fixed to the lid 26 and the three of lid 26, connection pipe 24 and filter 20 are inserted into and removed from the tank body 18 all together, there may be adopted a construction wherein the connection pipe 24 is made separable from the lid 26 and the two of connection pipe 24 and filter 20 are removed together with each other after removal of the lid 26.

In this case, as a construction for connecting the connection pipe 24 and an outer pipe with each other, there may be adopted, for example, a construction wherein the joint 24d used in the above embodiment is separated from the connection pipe 24 and is fixed to the lid 26, an integral combination of the filter 20 and the connection pipe 24 is set within the tank body 18, then in a mounted state of the lid 26, the joint 24d and the connection pipe 24 (outer pipe connecting portion 24c) are connected with each other automatically.

The filter loading/unloading structure described above is suitable for the return oil filter in point of maintenance frequency being high, but is also applicable to the feed oil filter, or may be applied to both return oil filter and feed oil filter at a time.

Although the invention has been described with reference to the preferred embodiments in the attached figures, it is noted that equivalents may be employed and substitutions made herein without departing from the scope of the inventions as recited in the claims.

I claim:

1. A hydraulic oil tank of a construction machine, comprising:
a box-like tank body for storing hydraulic oil;
a filter for filtering the hydraulic oil, the filter being disposed at a position lower than a highest level of the hydraulic oil in said tank body;
a removable lid for closing a window hole-like filter loading/unloading port for loading and unloading said filter, said filter loading/unloading port being formed at a position higher than the highest level of the hydraulic oil in one of front, rear, right, and left side faces of said tank body; and
a connection pipe for connection between said filter and an outer pipe, said connection pipe being connected integrally with the filter and disposed within said tank body so that it can be inserted and removed sideways into and from the tank body through said filter loading/unloading port.

2. The hydraulic oil tank of a construction machine according to claim 1, wherein said outer pipe is a return oil outer pipe for conducting return oil leaving a hydraulic actuator into said hydraulic oil tank, said connection pipe is connected to said return oil outer pipe, and said filter is a return oil filter for filtering return oil and is connected to said connection pipe.

3. The hydraulic oil tank of a construction machine according to claim 1, wherein one end of said connection pipe is connected to said filter and an opposite end thereof is connected to said lid.

4. The hydraulic oil tank of a construction machine according to claim 1, wherein said connection pipe comprises an inclined main pipe, a filter connecting portion formed on one end side of said main pipe, and an outer pipe connecting portion formed on an opposite end side of said main pipe, said filter connecting portion and said outer pipe connecting portion extending horizontally, said filter connecting portion being connected to said filter and said outer pipe connecting portion being connected to said outer pipe in a state in which said main pipe is inclined forwardly downward from said filter loading/unloading port side toward said filter within said tank body.

5. A construction machine comprising:
a lower traveling body;
an upper rotating body mounted on said lower traveling body so as to be rotatable about a vertical axis;
an engine room formed in said upper rotating body, with an engine and devices including a hydraulic oil tank being installed in said engine room; and
said hydraulic oil tank, said hydraulic oil tank being the hydraulic oil tank described in claim 1 and being installed on an outer periphery side of said engine room in a state in which said filter loading/unloading port faces the exterior when the engine room is opened to the exterior.
